(19) United States
(12) Patent Application Publication
(10) Pub. No.: US 2017/0060926 A1
(43) Pub. Date: Mar. 2, 2017

(54) Method and a system for storing and exchanging plant growth recipes via communication networks

(71) Applicant: Wanjun Gao, Weston, FL (US)

(72) Inventor: Wanjun Gao, Weston, FL (US)

(21) Appl. No.: 14/840,026

(22) Filed: Aug. 30, 2015

(51) Int. Cl. G06F 17/30

(52) U.S. Cl. CPC G06F 17/30342

(57) ABSTRACT

The invention is a method and a system for storing and exchanging recipes for controllable plant growth systems via communication networks. A controllable plant growth system uses recipes as templates to deliver necessities such as light, nutrients, oxygen, or CO2 for plants to grow, and utilizes heaters and/or coolers to regulate the enclosed environment settings such as temperature and humidity. A recipe store is a remotely accessible digital repository for growth recipes, can be remotely accessed either via a direct communications network from system or through user management interface of the system as a intermediary component, and provides functions for storing, sorting and searching recipes via APIs or user interfaces.

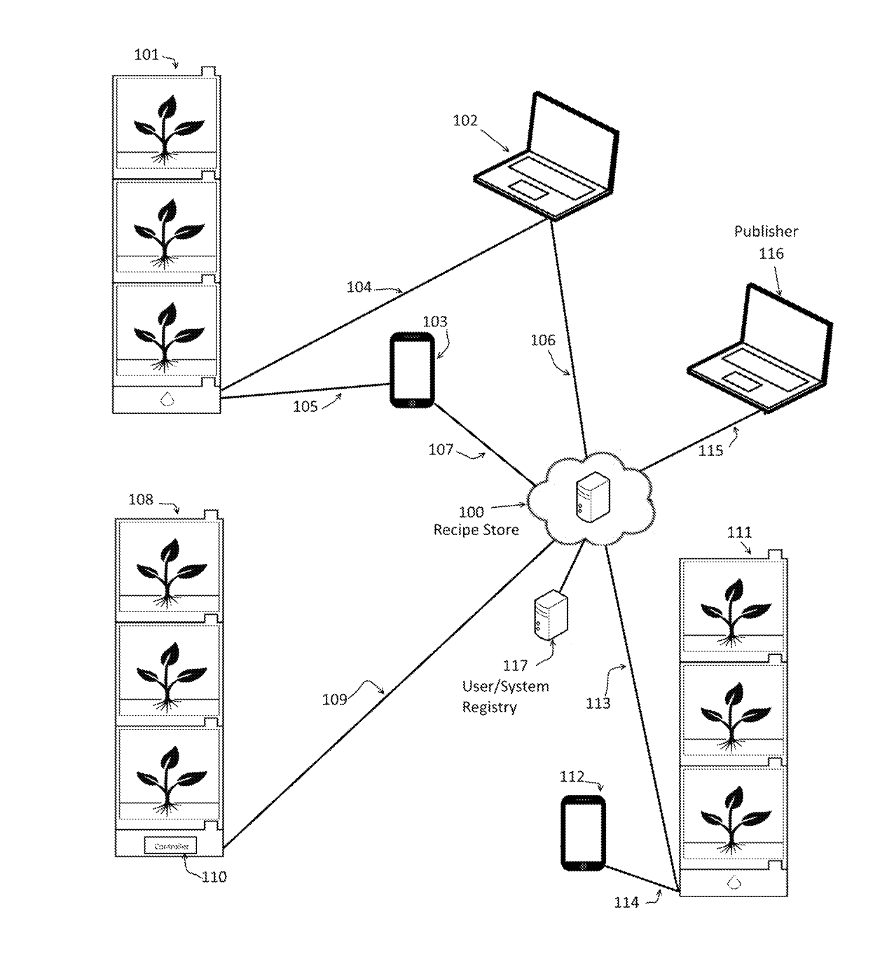

### CROSS-REFERENCE TO RELATED APPLICATIONS

Provisional patent application U.S. 62/146,394 filed on Apr. 12, 2015

### BACKGROUND OF THE INVENTION

Existing human/system controllable plant growth systems, including Hydroponic, aeroponic, and aquaponic systems, utilize sensors to monitor plant environments, devices such as light fixtures, sprayers, water pumps, and fans to deliver light, nutrients, oxygen, or CO2 for plants to grow, and heaters and/or coolers to regulate environmental settings such as temperature and humidity.

While these growth systems enable the creation and maintenance of optimal conditions for plant growth, they require regular users to provide the settings for different plants. It is a challenge for regular users who may lack knowledge for specific plants.

Each type of plants has its own characters and requires different environmental settings or delivery schedules for light, nutrients, oxygen, CO2, etc. Users have to either operate by experience and trial, or seek and obtain knowledge from other people, online forums or training classes.

### BRIEF SUMMARY OF THE INVENTION

The invention is a method and a system for storing and exchanging plant growth recipes via communication networks.

A recipe is a template with growth system environmental settings, necessities delivery schedules, and other information that growth systems rely on to operate. A networked recipe store is a digital repository for growth recipes, accessible by the growth systems via a communication connection or through user interface of the system on computers or mobile devices. The store provides functions for users to upload, download, and exchange recipes. It maximizes knowledge sharing and increases productivities. The recipe store saves recipe data for future use. It also provides sorting and searching functions for system-specific or plant specific recipes upon requests from growth systems.

Users and experts can create recipes and publish them either from the plant growth systems directly, or through the store's publishing utilities without a growth system. Users can instruct the recipe store to download recipes directly to growth system and apply recipe template.

As a result, the connected recipe store can aggregate knowledge from participating growth systems and users, making controlling growth systems easier and yielding better results with the plant growth.

### BRIEF DESCRIPTION OF THE DRAWINGS

The drawing illustrated a sample system for storing and exchanging recipes for controllable plant growth systems via communication networks and is consisted of controllable plant growth systems, a recipe store, and remote devices for management of the recipe store.

### DETAILED DESCRIPTION OF THE INVENTION

The drawing illustrated a sample system for storing and exchanging recipes for controllable plant growth systems via communication networks. The system is consisted of controllable plant growth systems 101, 108, and 111, a recipe store 100, communication networks 104, 105, 106, 107, 109, 113, 114, and 115, remote mobile devices 103 and 112, and remote computers 102 and 116.

The plant growth systems 101, 108 and 111 utilize sensors to monitor plant environments, devices such as sprayers, pumps, and fans to deliver necessities such as light, nutrients, oxygen, or CO2 for plants to grow, and heaters or coolers to regulate the enclosed environment's temperature and humidity. The plant growth system can be hydroponic, aeroponic, aquaponic, or other human/system controllable growth system.

The users of plant growth systems 101, 108, and 111 need to make sure the growth systems are configured with the optimal conditions for the plants to grow. A plant growth recipe is a collection of growth system environmental settings, necessities delivery schedules, and other information that growth systems rely on to operate. Recipes are set with applicable conditions, such as growth system models, geological conditions, and targeted users. Recipes are consisted of environmental settings and necessities delivery schedules for stages of the plants life cycles.

Creating plant growth recipes is accomplished by compiling recipes in computer data formats for specific systems and specific plants. Publishing recipes is accomplished by sending recipe data to a recipe store 100 via communication networks. Recipes can be published from the plant growth system controller 110 directly, or through the store's publishing utilities that are assessable on computers 116 and 102 or mobile devices 103 and 114. Recipe data are saved into recipe store 100. Recipe store 100 is located remotely from the growth systems 101, 108 and 111, while it is accessible by the three growth systems. Functions of sorting and searching recipe data are provided via computer Application Programming Interface for the growth systems and User Interface for the users.

The plant growth systems 101, 108, and 111 acquire recipes by getting access to and retrieving recipe data in computer data formats from a recipe store 100 via communication networks 109, 104, 105, 106, 107, and 113. They then apply the recipes for different plants by extracting recipe content from the acquired recipe data from the recipe store 100 and using the data to configure the plant growth system. Users may customize the acquired recipes based on their own needs.

The recipe store 100 can optionally provide Access Right management for recipe published in the store, so access of the recipes can be restricted to targeted users/systems only. A system/user registry 117 is a directory that stores user and system identity information. This system is used to authenticate and authorize users and growth systems to access recipe store.

Having described my invention, I claim:

1. A method for storing and exchanging recipes for controllable plant growth systems via communication networks.

2. A method as recited in claim 1, wherein connecting the systems is accomplished by authenticating, authorizing and establishing network communications between plant growth systems and a recipe store.

3. A method as recited in claim 1, wherein a plant growth recipe is a template of growth system environmental settings, necessities delivery schedules, and other information that growth systems rely on to operate.

4. A method as recited in claim 1, wherein recipes are set with applicable conditions, such as growth system models, geological conditions, and targeted users.

5. A method as recited in claim 1, wherein recipes are consisted of environmental settings and necessities delivery schedules for stages of the plants life cycles.

6. A method as recited in claim 1, wherein creating plant growth recipes is accomplished by compiling recipes in computer data formats for specific systems and specific plants.

7. A method as recited in claim 1, wherein publishing recipes is accomplished by sending recipe data to a recipe store via communication networks. Recipes can be published from the system directly, or through the store's publishing utilities.

8. A method as recited in claim 1, wherein saving recipe data is accomplished by storing recipe data into recipe repositories. Recipe repositories are usually located remotely from the growth systems while they are accessible by the growth systems.

9. A method as recited in claim 1, wherein functions of sorting and searching recipe data are provided via computer Application Programming Interface for the growth systems and User Interface for the users.

10. A method as recited in claim 1, wherein acquiring recipes is accomplished by getting access to and retrieving recipe data in computer data formats from a recipe store.

11. A method as recited in claim 1, wherein applying a recipe is accomplished by extracting recipe content from the acquired recipe data from the recipe store and using them to configure the plant growth system. Users may customize the acquired recipes based on their own needs.

12. A system that operates based on the method as recited in claim 1, is consisted of controllable plant growth systems, a recipe store, a system/user registry, and remote devices for management of the recipe store, and is used for storing and exchanging recipes for controllable plant growth systems via a communications network.

13. A system as recited in claim 12, wherein a plant growth system utilizes sensors to monitor plant environments, devices such as sprayers, pumps, and fans to deliver necessities such as light, nutrients, oxygen, or CO2 for plants to grow, and heaters or coolers to regulate the enclosed environment's temperature and humidity. The plant growth system can be hydroponic, aeroponic, aquaponic, or other human/system controllable growth system.

14. A system as recited in claim 12, wherein the plant growth system is capable of accessing and retrieving recipe store via communication networks and using the retrieved recipes as templates to operate.

15. A system as recited in claim 12, wherein a recipe store is a remotely accessible digital repository for growth recipes, can be remotely accessed either via a direct communication network from system or through user management interface of the system as a intermediary component, and provides functions for storing, sorting and searching recipes.

16. A system as recited in claim 12, wherein a recipe store provides utilities for users to create and publish recipes directly to the store without a plant growth system.

17. A system as recited in claim 12, wherein a recipe store can optionally provide Access Right management for recipe published in the store, so access of the recipes can be restricted to targeted users/systems only.

18. A system as recited in claim 12, wherein a system/user registry is a directory that stores user and system identity information. This system is used to authenticate and authorize users and growth systems to access recipe store.
